(19) United States
(12) Patent Application Publication
(10) Pub. No.: US 2014/0206214 A1
(43) Pub. Date: Jul. 24, 2014

(54) POWER PLUG

(71) Applicants: Hong Fu Jin Precision Industry (ShenZhen) Co., Ltd., (US); HON HAI PRECISION INDUSTRY CO., LTD., New Taipei (TW)

(72) Inventors: GUI-FU XIAO, Shenzhen (CN); LI-REN FU, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/830,662

(22) Filed: Mar. 14, 2013

(30) Foreign Application Priority Data
Jan. 24, 2013 (CN) 201310026738.0

(51) Int. Cl. H01R 13/635

(52) U.S. Cl. CPC H01R 13/635
USPC 439/160

(57) ABSTRACT

A power plug includes a main body and a rotating member rotatably connected to the main body. The rotating member includes a levering portion at a side of the point of rotation of the main body. The rotating member is rotated, to lever the power plug out of a power socket.

### BACKGROUND

1. Technical Field

The present disclosure relates to an electrical power plug.

2. Description of Related Art

With the development of electronic technology, a great number of large-sized power plugs are being used in electronic devices, and, in use, the power plugs are tightly connected to power sockets. However, unplugging the power plugs from the power sockets by hand can often be difficult and inconvenient due to tight engagement.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawing, all the views are schematic, and like reference numerals designate corresponding parts throughout the several views.

FIG. 1 is an exploded, isometric view of an exemplary embodiment of a power plug.

FIG. 2 is an assembled, isometric view of the power plug of FIG. 1.

FIG. 3 is similar to FIG. 2, but shows the power plug in use.

FIGS. 4 and 5 are side plan views of the power plug of FIG. 3 with a power socket, but showing the power plug plugged into the power socket and being unplugged from it.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

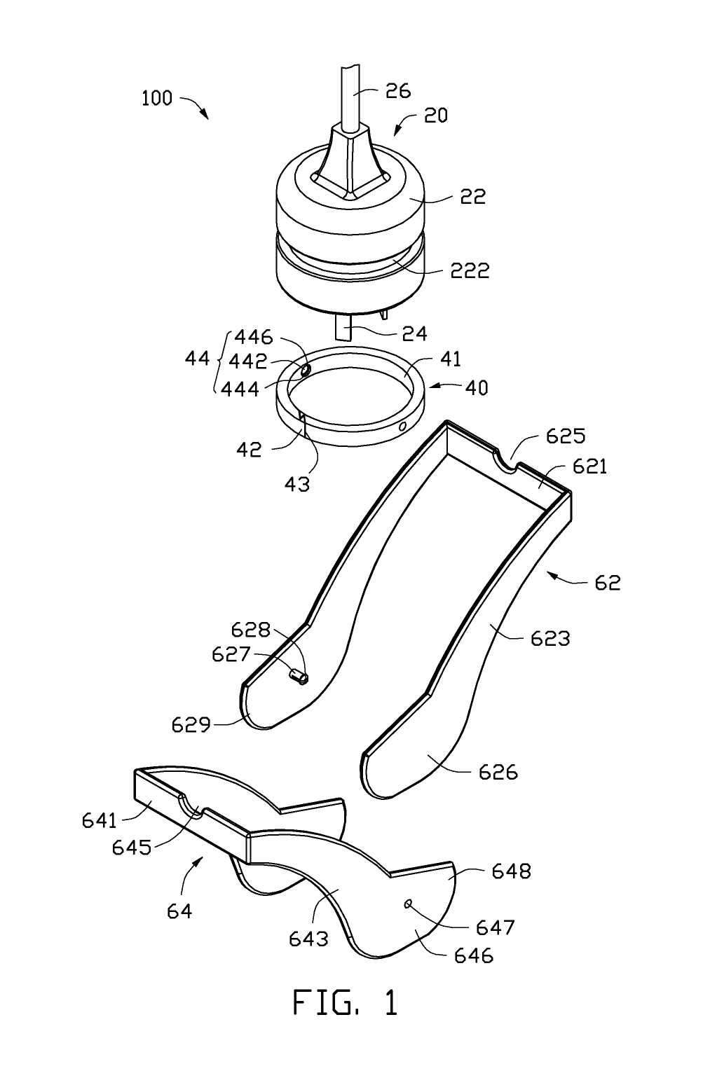

FIG. 1 shows an exemplary embodiment of a power plug 100 including a main body 20, a connecting member 40, a first rotating member 62, and a second rotating member 64.

The main body 20 includes a substantially cylindrical shell 22, three pins 24 installed to the shell 22 and extending out of a bottom end of the shell 22, and a cable 26 extending out of a top end of the shell 22 and electrically connected to the pins 24. A middle of a circumference of the shell 22 defines a circumferential groove (annular receiving slot 222). The shell 22 is made of flexible and insulating material, such as plastic.

The connecting member 40 includes a resilient ring 41 which is split, and a seam 43 marks the split. Two clamped hooks 42 are formed at the opposing ends of the ring 41, engaging each other at the seam 43. Two stepped holes 44 are diametrically opposite each other. Each stepped hole 44 includes a first hole 442 extending through an outer surface of the ring 41, a second hole 444 communicating with the first hole 442 and extending through an inner surface of the ring 41. The diameter of the second hole 444 is greater than that of the first hole 442. Thus, a stepped portion 446 is formed in the stepped hole 44, between the first hole 442 and the second hole 444.

The first rotating member 62 is substantially U-shaped, and includes two opposite abutting plates 626, two connecting plates 623 arced up and rearward from rear ends of the abutting plates 626, and an operation plate 621 perpendicularly connected between the rear ends of the connecting plates 623 opposite to the abutting plates 626. A middle of a top side of the operation plate 621 defines a cutout 625, of a size and shape to accomodate the cable 26. Two opposite shafts 627 extend toward each other from middles of the abutting plates 626. Each shaft 627 includes two separated and resilient hooks 628. Two arced first levering portions 629 are formed on front ends of the abutting plates 626 opposite to the connecting plates 623.

The second rotating member 64 is substantially U-shaped, and includes two opposite abutting plates 646, two connecting plates 643 arced up and forward from front ends of the abutting plates 646, and an operation plate 641 perpendicularly connected between front ends of the connecting plates 643 opposite to the abutting plates 646. A middle of a top of the operation plate 641 defines a cutout 645 of a similar size and shape as the cutout 625. Two opposite shaft holes 647 are defined in middles of the abutting plates 646 of a diameter greater than that of a shaft 627. Two arced second levering portions 648 are formed on rear ends of the abutting plates 646 opposite to the connecting plates 643.

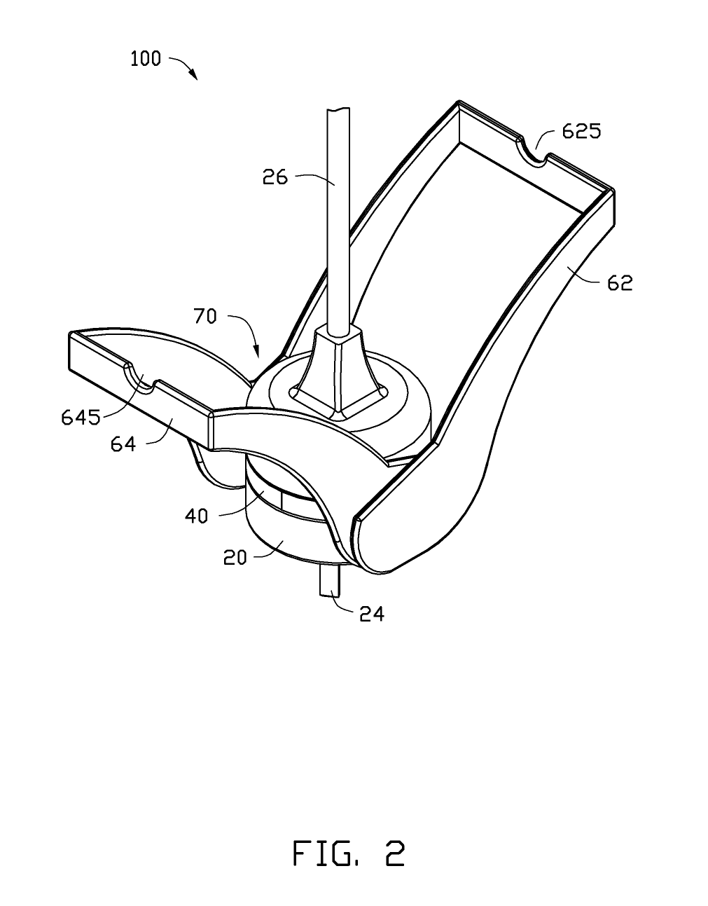

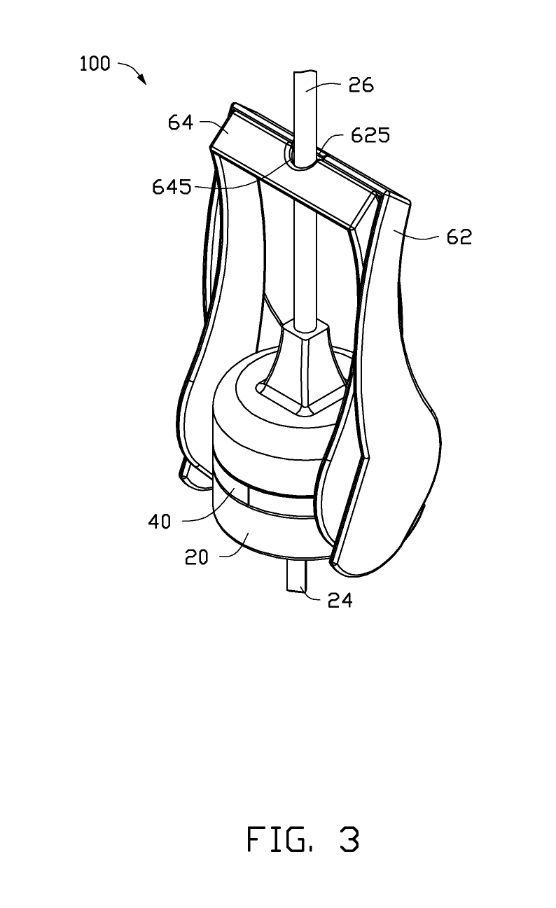

Referring to FIG. 2 and FIG. 3, in assembly, the hooks 42 of the ring 41 are disengaged from each other to enlarge the seam 43 by deforming the ring 41. The ring 41 is received in the receiving slot 222, and the hooks 42 are hooked with each other to restore the strength of the ring 41. The abutting plates 646 of the second rotating member 64 are attached to opposite sides of the ring 41, with the through holes 647 aligning with the stepped holes 44 of the connecting member 40. The connecting plates 623 of the first rotating member 62 are deformed away from each other. The shafts 627 of the first rotating members 62 are inserted into the through holes 647 of the second rotating member 64 and the first holes 442 of the connecting member 40, deforming the hooks 628 of each shaft 627 toward each other, until the hooks 628 pass through the second holes 444 of the connecting member 40. The hooks 628 restore and are held captive by the stepped portions 446. The shafts 627 are thus rotatably received in the stepped holes 44. Thus, the shafts 627 and the stepped holes 44 cooperatively form a rotation junction 70, and the first rotating member 62 and the second rotating member 64 are rotatably connected to the connecting member 40 about the rotation junction 70.

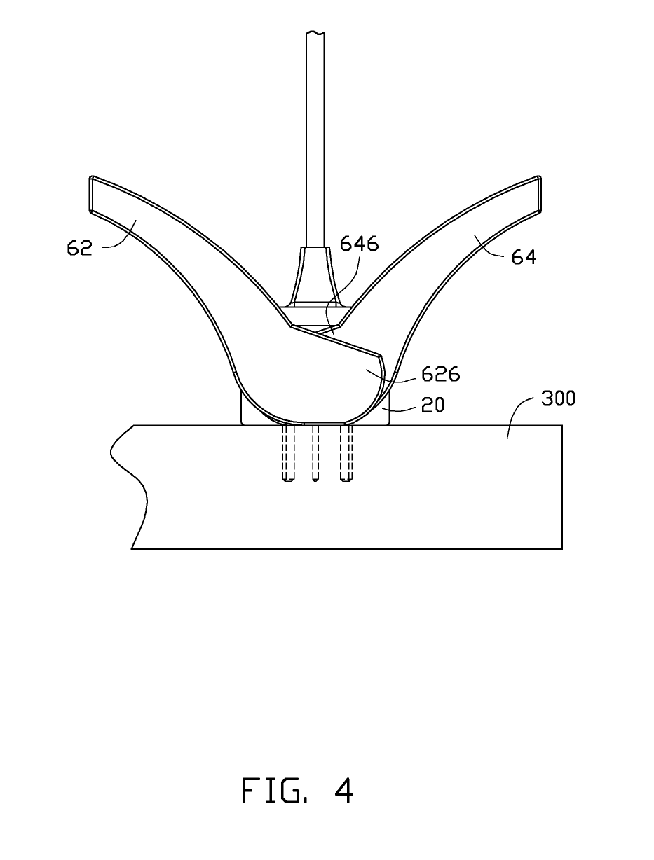

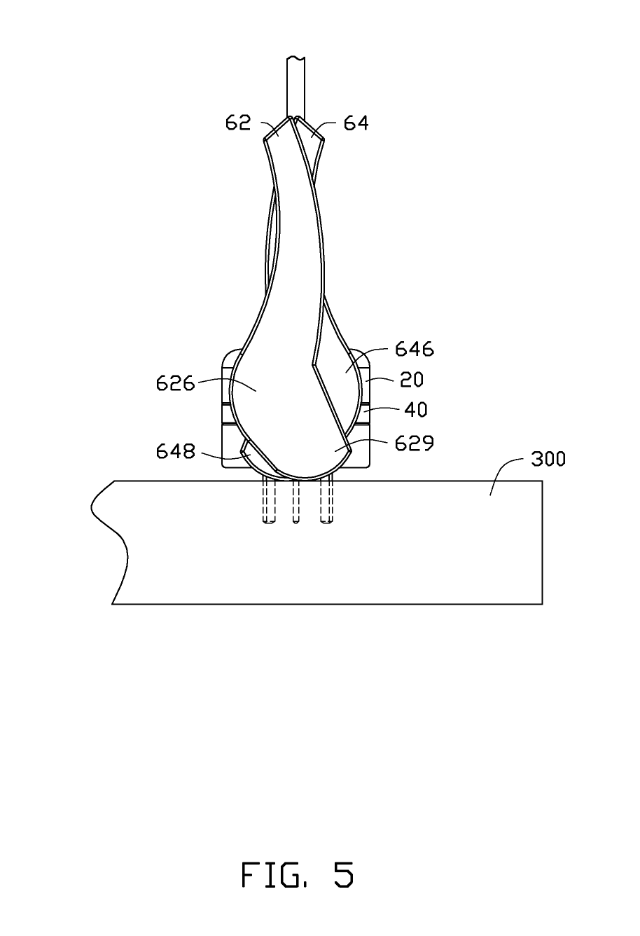

Referring to FIG. 4 and FIG. 5, in use, the power plug 100 is plugged into a power socket 300. Bottoms of the first rotating member 62 and the second rotating member 64 abut against a top surface of the power socket 300. To unplug the power plug 100 from the power socket 300, the operation plates 621 and 641 are moved toward each other in the manner of folding wings, the first rotating member 62 and the second rotating member 64 rotating about the shafts 627, until the cable 26 is received between the cutout 625 of the first rotating member 62 and the cutout 645 of the second rotating member 64. The first and second levering portions 629 and 648 slidably abut against the top surface of the power socket 300, and lever up the main body 20. The pins 24 are thus disengaged from the power socket 300, and the power plug 100 removed from the power socket 300.

Even though numerous characteristics and advantages of the embodiments have been set forth in the foregoing description, together with details of the structure and the functions of the embodiments, the disclosure is illustrative only, and changes may be made in details, especially in the matters of shape, size, and arrangement of parts within the principles of the embodiments to the full extent indicated by the broad general meaning of the terms in which the appended claims are expressed.

What is claimed is:

1. A power plug, comprising:
a main body comprising a shell, a plurality of pins extending out of a bottom of the shell, and a cable extending out of a top of the shell and electrically connected to the plurality of pins; and
a first rotating member rotatably connected to the main body, the first rotating member comprising a first abutting plate rotatably connected to the shell, at a side of a rotation junction of the first rotating member and the shell, wherein the first rotating member is operable of rotating, allowing a distal end of the first abutting plate opposite to the rotation junction of the first rotating member and the shell to extend beyond the bottom of the shell.

2. The power plug of claim 1, further comprising a connecting member mounted to the shell, wherein the first rotating member is rotatably connected to the connecting member.

3. The power plug of claim 2, wherein the shell defines a receiving slot, the connecting member is received in the receiving slot.

4. The power plug of claim 3, wherein the shell is substantially cylindrical, the plurality of pins extends out of a bottom end of the shell, and the cable extends out of a top end of the shell, the receiving slot is defined in a circumference of the shell, the connecting member is ring-shaped.

5. The power plug of claim 4, wherein the connecting member defines a seam, two clamped hooks are formed on the connecting member and at two opposite sides of the seam.

6. The power plug of claim 4, wherein the first rotating member further comprises a first operation plate at an opposite side of the rotation junction of the first rotating member and the shell.

7. The power plug of claim 6, wherein the first rotating member further comprises a first connecting plate connected between the first operation plate and the first abutting plate.

8. The power plug of claim 7, wherein the connecting member defines two stepped holes aligning with each other, two opposite shafts extend from the first resisting plates rotatably inserted into the stepped holes.

9. The power plug of claim 8, wherein each stepped hole comprises a first hole extending through an outer surface of the connecting member, a second hole communicating with the first hole and extending through an inner surface of the connecting member, a diameter of the first hole is less than a diameter of the second hole, and a stepped portion is formed in the stepped hole, between the first hole and the second hole, each shaft comprises a resilient hook extending through the corresponding first hole and is abutted against the stepped portion.

10. The power plug of claim 8, wherein the first operation plate defines a cutout for receiving the cable.

11. The power plug of claim 8, further comprising a second rotating member, wherein the second rotating member comprises a second operation plate and a second abutting plate extending from an end of the second operation plate, the second abutting plate is rotatably sandwiched between the connecting member and the first abutting plate.

12. The power plug of claim 11, wherein the second abutting plate defines a through hole, the shaft of the first rotating member is extended through the through hole of the second rotating member and is inserted into the stepped hole of the abutting member.

13. The power plug of claim 12, wherein an levering portion is formed on a distal end of the second abutting plate opposite to the second operation plate, the second abutting plate is operable of rotating, making the levering portion extend out of the bottom of the shell.

14. The power plug of claim 13, wherein the second levering portion is arced.

15. The power plug of claim 1, wherein the distal end of the first abutting plate forms an arced levering portion.

16. A power plug, comprising:
a main body comprising a shell, two pins extending out of a bottom of the shell, and a cable extending out of a top of the shell and electrically connected to the pins; and
a first rotating member comprising two first abutting plates and a first operation plate connected between first ends of the first abutting plates, middles of the first abutting plates rotatably mounted to the shell; wherein the first rotating member is operable of rotating, allowing second ends of the first abutting plates opposite to the first operation plate to extend beyond the bottom of the shell.

17. The power plug of claim 16, further comprising a second rotating member, wherein the second rotating member comprises two second abutting plates and a second operation plate connected between first ends of the second abutting plates, middles of the second abutting plates are rotatably mounted to the shell; wherein the second rotating member is operable of rotating, allowing second ends of the second abutting plates opposite to the second operation plate to extend out of the bottom of the shell.

18. The power plug of claim 17, wherein two shafts extend in from the middles of the first abutting plates, the middles of the second abutting plates define two through holes, the shafts rotatably extend through the through holes, and engage in opposite sides of the shell.
